(19) United States
(12) Patent Application Publication
(10) Pub. No.: US 2023/0016841 A1
(43) Pub. Date: Jan. 19, 2023

(54) PLANT FOR PASTEURIZING FOODSTUFFS OR BEVERAGES FILLED INTO CLOSED CONTAINERS BY WAY OF A PROCESS LIQUID

(71) Applicant: Krones AG, Neutraubling (DE)

(72) Inventors: Jens Luecke, Flensburg (DE); Jan Muenzer, Harrislee (DE)

(21) Appl. No.: 17/780,901

(22) PCT Filed: Sep. 15, 2020
(86) PCT No.: PCT/EP2020/075707

§ 371 Date: May 27, 2022

(30) Foreign Application Priority Data
Dec. 5, 2019 (DE) 10 2019 133 184.6

(51) Int. Cl. A23L 3/02; A23L 2/46; A23L 3/00

(52) U.S. Cl. CPC A23L 3/02; A23L 2/46; A23L 3/003

(57) ABSTRACT

The invention relates to a plant (1, 42, 53, 56) for pasteurizing foodstuffs/beverages in containers by way of a process liquid (13), having:
at least one heating zone (6, 7), pasteurizing zone (8-10) and cooling zone (11, 12), wherein each of said zones is assigned a sprinkling device (14-20) for discharging the process liquid and a collecting region (23-29) for receiving the discharged process liquid,
a first heat exchanger (31) which feeds heat from a heat source (32) to the process liquid from a collecting region of the at least one pasteurizing zone and which, for this purpose, has a line connection to said collecting region and to inlets to sprinkling devices of the at least one heating zone via a pressure-closed heating line system (95),
a second heat exchanger (30) which is coupled to a cooling system in order to cool the process liquid from the collecting region of the at least one cooling zone and which, for this purpose, has a line connection to said collecting region and to inlets to sprinkling devices of the at least one cooling zone via a pressure-closed cooling line system (96),
wherein the process liquid can additionally be fed heat in the heating line system by means of a condenser (37) of a heat pump (35), and the process liquid can additionally be cooled in the cooling line system by means of an evaporator (39).

### RELATED APPLICATIONS

This application claims the benefit of International Application No. PCT/EP2020/075707, filed Sep. 15, 2020 which claims priority to German Application No. DE102019133184.6, filed Dec. 5, 2019. The entire contents of both applications are hereby incorporated by reference.

### TECHNICAL FIELD

The present disclosure relates to a plant for pasteurizing foodstuffs and/or beverages filled into closed containers by way of a process liquid.

### BACKGROUND

Plants are already known which use a heat pump in conjunction with tunnel pasteurizers. There are basically two known types of connections for connecting the heat pump to the pasteurizer.

In one type of connection, for example, the heat pump can be integrated directly into the process water cycle of two zones; this is disclosed in JP 2012166806, FR 2520984 and DE 10 2007 003 919 A1, among others. Usually, the heat pump is placed between the last cooling zone and one of the other zones.

With this type of connection, the cooling/heating energy of the heat pump can only be used in two zones and not in the entire machine. Switching between different zones that could be used for connection to the heat pump is constructively very complex. Therefore, with this type of connection, the heat pump is always permanently connected to the same pair of zones. If, due to certain operating conditions (e.g. stop-and-go operation), mainly heating or cooling energy is required in the other zones that are not connected to the heat pump, no advantage can be obtained from the heat pump. In addition, the heat exchangers for connecting the heat pump are always flowed through as well, unless there is a bypass pipe, so that additional pressure losses can occur even when the heat pump is switched off.

In the other type of connection, a hot and/or cold water tank can be connected directly to the pipe system of the process water of all zones as a heat or cold reservoir; this is disclosed in WO 2017/055501 and EP3378330 A1, among others. In this case, the water balance between the pasteurizer vat and the tanks takes place in the open system via the geodetic height, i.e. without overpressure, since these tanks are open at the top. As a result, the tanks must either be integrated into the pasteurizer or located in the immediate vicinity at a fixed geodetic height to the pasteurizer. A heating or cooling plant is then connected to these tanks. The heat pump is connected between the heating and cooling systems. The installation of the tanks and the adjustment of the water levels during the commissioning phase are therefore much more complex compared to a heating-cooling system with a closed, pressured system. Depending on the spatial conditions in the hall, constantly changing installation situations can arise. The consequently different lengths of connection piping can significantly influence the overall control behavior of the pasteurizer in an open system.

### SUMMARY

The present disclosure is based on the object of providing a plant for pasteurizing foodstuffs or beverages filled in closed containers by way of a process liquid, which allows positioning of plant elements for heating or cooling the process liquid independently of the position of the rest of the plant.

Described herein is a plant for pasteurizing foodstuffs or beverages filled in closed containers, such as bottles, cans, with a process liquid comprises at least one heating zone, at least one pasteurizing zone and at least one cooling zone, which are arranged successively in a conveying direction of the containers. Each of the zones is associated with a respective sprinkling device for dispensing the process liquid and is associated a respective collecting region for receiving the dispensed process liquid.

Further, the plant comprises conveying means, such as a conveyor belt, or a conveyor chain, for conveying the containers in the conveying direction through the at least one heating zone, the at least one pasteurizing zone, and the at least one cooling zone.

In addition, a first heat exchanger (HE) is provided which supplies heat from a heat source, such as from a steam or hot water source, to the process liquid from a collecting region of the at least one pasteurizing zone and, for this purpose, has a line connection to the one collecting region of the at least one pasteurizing zone and to feeds to the sprinkling devices of the at least one heating zone via a pressure-closed heating line system.

Further, a second HE is provided which is coupled to a cooling system, such as a cooling tower, for cooling the process liquid from the collecting region of the at least one cooling zone and, for this purpose, has a line connection to the at least one collecting region of the at least one cooling zone and feeds to the sprinkling devices of the at least one cooling zone via a pressure-closed cooling line system.

The plant further comprises a heat pump comprising a condenser and an evaporator, wherein heat can additionally be supplied to the process liquid in the heating line system via the condenser and wherein the process liquid can additionally be cooled in the cooling line system via the evaporator.

The term “having a line connection” as used herein can be understood to mean that between two or more elements connected by a pipeline, e.g., collecting region and heat exchanger, one or more pipelines are provided through which, for example, a medium can flow that is to pass, for example, from the collecting region to the heat exchanger.

A tunnel pasteurizer or other type of pasteurizer may include the heating, pasteurizing, and cooling zones, the sprinkling devices, and collecting regions. The process liquid may be or include fresh water or fresh water with additives.

The heating, pasteurizing and cooling zones are generally located at a different height than the heat pump and heat exchangers of the plant.

The heating or cooling line system refers to one or more pipelines that are adapted in such a way that liquid media, such as the process liquid, can flow through them. The heating and cooling line systems are each adapted to be pressure-closed, which means that an overpressure can be formed in the respective pipe systems with respect to the ambient pressure. Due to the pressure-closed configuration, it is not necessary to arrange the heating, pasteurizing and cooling zones and the heat pump and the heat exchangers of the plant with respect to the geodetic height. For example, the heat pump and the heat exchangers can be arranged above the heating, pasteurizing and cooling zones, for example above the tunnel pasteurizer and/or also on another floor; the corresponding height can be specified here by the overpressure in the heating or cooling line system.

In embodiments of the present disclosure, (a) no buffer tank or other tank can be provided in the plant, (b) no buffer tank or other tank having ambient pressure can be provided in the plant, but tanks having an overpressure may be provided, (c) no buffer tank or other tank having ambient pressure can be provided in the heating or cooling line system.

The first HE may be further connected by a pipeline with feeds to the sprinkling devices of the at least one pasteurizing zone via the heating line system, optionally the first HE may be further connected by a pipeline with feeds to the sprinkling devices of the at least one heating zone via the heating line system. The second HE may be further connected by a pipeline with feeds to the sprinkling devices of the at least one cooling zone via the cooling line system, optionally the second HE may further be connected by a pipeline with feeds to the sprinkling devices of the at least one pasteurizing zone via the cooling line system.

By connecting pipes to different sprinkling devices, greater variability in the distribution of heated or cooled process liquid can be achieved.

A first overpressure in a range of 0.5·10⁵ Pa to 2.5·10⁵ Pa may be provided in the heating line system relative to an ambient pressure and/or a second overpressure in a range of 0.5·10⁵ Pa to 2.5·10⁵ Pa may be provided in the cooling line system relative to the ambient pressure, wherein the first and second overpressures may be equal or different in magnitude.

The provision of an overpressure in the heating or cooling line system enables the positioning of plant elements for heating or cooling the process liquid independently of the position of the rest of the plant, since there is no need to pay attention to the geodetic height, as is the case with an open line system.

From the collecting region of the at least one cooling zone, the process liquid can be supplied to a first inlet of the second HE via a first pump via the cooling line system.

An amount of supplied heat from the heat source can be controllable via a metering device. For example, the amount of steam or hot water introduced can be controlled.

The process liquid from the collecting region of the at least one pasteurizing zone can be supplied to a second inlet of the first HE via a second pump via the heating line system.

In one embodiment, a first bypass to the condenser may be provided in the heating line system and a second bypass to the evaporator may be provided in the cooling line system, wherein optionally the first bypass may be provided upstream of the first HE, wherein optionally the second bypass may be provided upstream of the second HE.

It is thus possible to add further heat to the process liquid or to cool the process liquid further.

The first bypass may lead from the heating line system through a first metering device to a first inlet of the condenser, through the condenser, and from a first outlet of the condenser back to the heating line system, and the second bypass may lead from the cooling line system through a second metering device to a first inlet of the evaporator, through the evaporator, and from a first outlet of the evaporator back to the cooling line system.

A heat tank may further be provided in the first bypass and a cooling tank may further be provided in the second bypass. The tanks enable intermediate storage of the heated or cooled process liquid, so that even in the event of a non-constant demand, a suitable supply of the corresponding process liquid to the sprinkling devices of the various zones is possible.

Downstream of the first metering device, a first inlet may be provided to the heat tank, and a first outlet of the heat tank may lead through a third pump to the first inlet of the condenser, wherein the first outlet of the condenser may lead to a second inlet of the heat tank, and a second outlet of the heat tank may lead through a fourth pump and a third metering device back to the heating line system. Downstream of the second metering device, a first inlet may be provided to the cooling tank, and a first outlet of the cooling tank may lead through a pump to the first inlet of the evaporator, wherein the first outlet of the evaporator may lead to a second inlet of the cooling tank and a second outlet of the cooling tank may lead through a sixth pump and a fourth metering device back to the cooling line system.

A first spring valve may be provided between the first metering device and the first inlet of the heat tank, and a second spring valve may be provided between the fourth pump and the third metering device.

A third spring valve may be provided between the second metering device and the first inlet of the cooling tank, and a fourth spring valve may be provided between the sixth pump and the fourth metering device.

This makes it possible to disconnect the heat pump so that there are no additional pressure losses or other disadvantages compared to a plant without a heat pump when the heat pump is not needed.

In another embodiment, without a bypass, the plant may comprise a third HE through which the heating line system may at least partially pass, the third HE supplying heat to the process liquid in the heating line system from a heat tank of the plant and being connected by a pipeline to the heat tank and the condenser for this purpose, and a fourth HE through which the cooling line system can at least partially pass, the fourth HE being adapted to be in communication with a cooling tank of the plant and the evaporator and to cool the process liquid in the cooling line system.

The third HE may be provided upstream of the first HE and the fourth HE may be provided upstream of the second HE.

A pipe may extend downstream of a first outlet of the third HE to a first inlet of the heat tank, from a first outlet of the heat tank through a third pump to a first inlet of the condenser, from a first outlet of the condenser to a second inlet of the heat tank, from a second outlet of the heat tank through a fourth pump to a first inlet of the third HE. A further pipe may lead downstream of a first outlet of the fourth HE to a first inlet of the cooling tank, from a first outlet of the cooling tank through a fifth pump to a first inlet of the evaporator, from a first outlet of the evaporator to a second inlet of the cooling tank, from a second outlet of the cooling tank through a sixth pump to a first inlet of the fourth HE.

Thus, there are separate circuits in each case: one for the process liquid flowing through the first HE and the third HE, and one for liquid flowing through the heat tank, the third HE and the condenser, as well as one for the process liquid flowing through the second HE and the fourth HE, and one for the liquid flowing through the cooling tank, the evaporator and the fourth HE.

Alternatively, a pipe may lead downstream of a first outlet of the third HE to a first inlet of the heat tank, from a first outlet of the heat tank through a third pump to a first inlet of the condenser, from a first outlet of the condenser to a first inlet of the third HE, wherein further a bypass line may be provided around the third HE, which may lead from upstream of the first inlet of the third HE downstream of the first outlet of the third HE. Further, another pipe may lead from downstream of a first outlet of the fourth HE to a first inlet of the cooling tank, from a first outlet of the cooling tank through a fifth pump to a first inlet of the evaporator, from a first outlet of the evaporator to a first inlet of the fourth HE.

Therefore, two pumps can be saved.

### BRIEF DESCRIPTION OF THE DRAWINGS

Some embodiments of the present disclosure are shown by way of the drawings.

FIG. 1 shows a first embodiment of a plant for pasteurization,

FIG. 2 shows a second embodiment of a plant for pasteurization,

FIG. 3 shows a third embodiment of a plant for pasteurization and

FIG. 4 shows a fourth embodiment of a plant for pasteurization.

### DETAILED DESCRIPTION

The embodiments of the plant for pasteurization described below include a given number of heating, pasteurizing and cooling zones, but embodiments with at least one heating zone, at least one pasteurizing zone and at least one cooling zone are also provided. Also, other collecting regions and sprinkling devices than described and/or shown in the Figures may be interconnected by a pipeline, generally with attention to the required temperature of the process liquid.

The line systems (heating or cooling line system), pipes and bypasses mentioned with reference to the Figures or further above refer to one or more pipelines adapted in such a way that liquid media, such as process liquid, can flow through them.

The positional designations “upstream” or “downstream” of an element of the plant refer to a direction of flow of a liquid medium, such as the process liquid, in the line systems, pipes or bypasses.

In the different embodiments described, the same parts are provided with the same reference numerals.

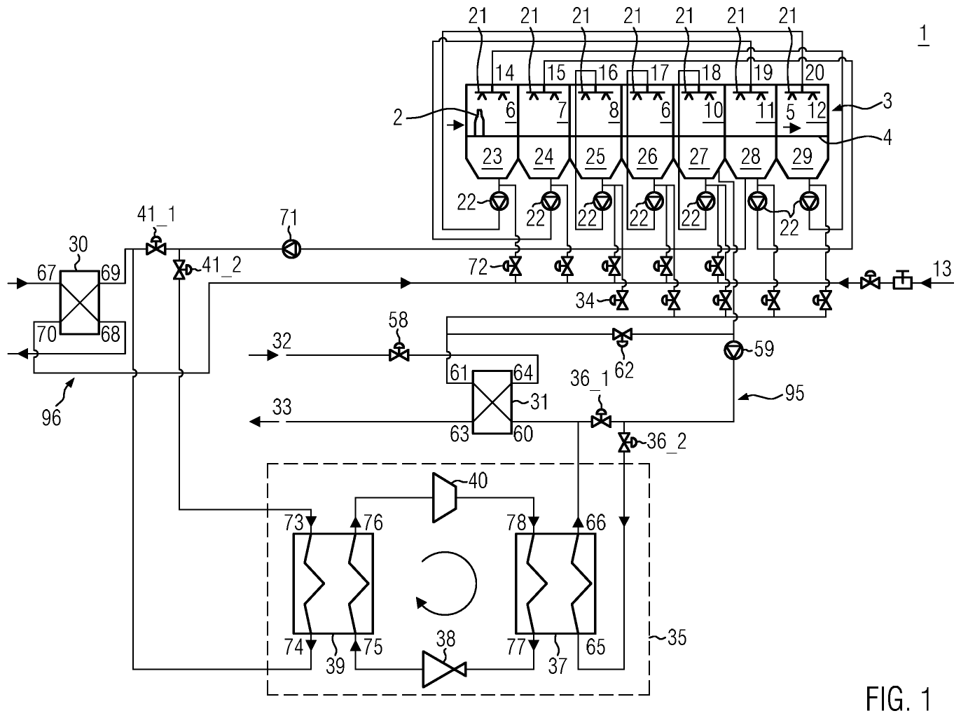

FIG. 1 schematically shows a first embodiment of a plant 1 for pasteurizing foodstuffs or beverages filled in closed containers 2. The plant 1 comprises, among other things, a tunnel pasteurizer 3 through which the containers 2 are transported via a conveying apparatus 4, for example a conveyor belt, in a conveying direction 5 through a plurality of successive zones 6, 7, 8, 9, 10, 11, 12. In the first embodiment shown in FIG. 1, firstly two heating zones 6, 7, then three pasteurizing zones 8, 9, 10 and finally two cooling zones 11, 12 are provided in the conveying direction 5. Instead of the tunnel pasteurizer, another type of pasteurizer can also be provided, comprising successive heating, pasteurizing and cooling zones, as well as associated sprinkling devices and collecting regions.

To pasteurize the foodstuffs or beverages, the containers 2 can be supplied with a process liquid 13. The process liquid can be fresh water or fresh water with additives. For this purpose, a sprinkling device 14, 15, 16, 17, 18, 19, 20 is arranged in each zone 6-12, with which the process liquid 13 is applied to the closed containers 2, e.g. sprayed or sprinkled. The sprinkling devices 14-20 may, for example, be formed by a plurality of spray nozzles 21 which are arranged in each zone 6-12, as shown, in an upper region, and/or may be arranged in lateral regions. The process liquid 13 can be introduced into the respective zone 6-12 via the respective sprinkling device 14-20, each with a different and/or set temperature for each zone 6-12. The process liquid 13 can be supplied to the sprinkling devices 14-20 of the zones 6-12 in each case via a pump 22, for example a circulation pump.

After trickling through a respective zone 6-12, the process liquid 13 can be collected in a collecting region 23, 24, 25, 26, 27, 28, 29, which is assigned to the respective zone 6-12, and discharged from the collecting region 23-29 for further use. The collecting regions 23-29 are arranged below the respective zones 6-12. For further use of the process liquid, the respective suction sides of the respective pump 22 are connected via pipes to the corresponding collecting regions 23-29 in order to feed at least partial quantities of the process liquid 13 from the corresponding collecting regions 23-29 back to one of the assigned zones 6-12, i.e. zones 6-12 connected by a pipeline. As shown in FIG. 1, it may be expedient here if the collecting region 23 of the first heating zone 6 has a line connection with the pump 22 on the inlet side, and the pump 22 has a line connection to the sprinkling device 20 of the second cooling zone 12 on the outlet side. This can be expedient, since the process liquid 13 in the first heating zone 6 cools down by heat absorption of the containers 2 or foodstuffs/beverages in the containers 2, and after trickling through the first heating zone 6, the process water 13 that accumulates in the collecting area 23 can have a temperature suitable for cooling the containers 2 in the second cooling zone 12.

Since in the second cooling zone 12 the process liquid 13 discharged by the sprinkling device 20 is heated by heat dissipation of the containers 2 or foodstuffs/beverages and, after trickling through the second cooling zone 12, the process water 13 which accumulates in the collecting region 29 can have a temperature suitable for heating the containers 2 in the first heating zone 6, it is expedient to feed the process liquid 13 from the collecting region 29 of the second cooling zone 12 to the sprinkling device 14 of the first heating zone 6, as is also shown schematically in FIG. 1.

As shown in FIG. 1, the pumps 22 associated with the pasteurizing zones 8-10 can be further provided for at least partial recirculation of the process liquid 13 from the collection region 25 to the sprinkling device 16, from the collection region 26 to the sprinkling device 17, and from the collection region 27 to the sprinkling device 18. Thus, at least part of the process liquid 13 can be circulated around the pasteurizing zones 8-10.

In the plant 1, a first heat exchanger (HE) 31 is also provided for heating the process liquid 13, into which steam 32 is introduced into a first inlet 64 and condensate 33 is discharged via a first outlet 63 after the steam 32 has flown in counterflow to the process liquid 13 originating from the collecting region 27 of the last pasteurizing zone 10. The amount of steam 32 introduced is controllable via a metering device 58. The process liquid 13 from the collecting region 27 is fed to a second inlet 60 of the first HE 31 via a pump 59 and by a metering device 36_1 via a pressure-closed heating line system 95 and, after being heated by the steam 32 transported in counterflow, leaves the first HE 31 via its second outlet 61 and re-enters the heating line system 95. If required, the process liquid 13 heated in the first HE 31 can be supplied to the zones 6-10 via metering devices 34 via the sprinkling devices 14-18 associated with the zones 6-10. Additionally or alternatively, the heated process liquid 13 or a portion thereof can also be circulated through the first HE 31, the flow rate being controllable via a metering device 62 in the heating line system 95. The heating line system 95 is adapted as a pressure-closed system and is operated with an overpressure relative to the ambient pressure, for example with an overpressure of 2·10⁵ Pa.

Furthermore, in the plant 1 it is provided that at least partial amounts of the process liquid 13 contained in the collecting region 28 of the first cooling zone 11, instead of being pumped back to the sprinkling device 15 of the second heating zone 7, are fed to a second HE 30. The second HE 30 may be coupled to a cooling plant, such as a cooling tower, to cool the process liquid 13 from the collecting region 28 and for this purpose has a line connection to the one collecting region 28 of the first cooling zone 11 and feeds to the sprinkling devices 19, 20 of the first 11 and second cooling zones 12 via a pressure-closed cooling line system 96. From the collecting region 28, the process liquid 13 is supplied via a first pump 71 and a metering device 41_1 via the cooling line system 96 to a first inlet 69 of the second HE 30 and leaves the second HE 30 after cooling via a first outlet 70. For cooling the process liquid 13 in the second HE 30, a coolant of the cooling plant is introduced into a second inlet 67 of the second HE 30, flows in counterflow to the process liquid 13 and absorbs heat therefrom. The heated coolant leaves the second HE 30 via a second outlet 68. The process liquid 13 cooled in the second HE 30 can then be returned to the sprinkling devices 16, 17, 18, 19, 20 via metering devices 72. The cooling line system 96 is adapted as a pressure-closed system and is operated with an overpressure relative to the ambient pressure, for example with a positive pressure of 2·10⁵ Pa.

Further, a first bypass to a condenser 37 of a heat pump 35 is provided in the heating line system 95. The first bypass leads through a first metering device 36_2 to a first inlet 65 of the condenser 37, through the condenser 37 and from a first outlet 66 of the condenser 37 back to the heating line system 95. The first bypass is arranged downstream of the second pump 59 and upstream of the second inlet 60 of the first HE 31. The flow rate of process liquid 13 through the first bypass is controllable via the metering device 36_2, this is useful because the heat pump 35 has limited heating capacity even if more process liquid 13 were to be passed through it.

The process liquid 13 is introduced into the condenser 37 through a first inlet 65, where it can absorb heat that is discharged by a transfer liquid that flows through the condenser 37 in counterflow. In this case, the transfer liquid flows through the condenser 37, a throttle 38, an evaporator 39, and a compressor 40 of the heat pump 35. The transfer liquid is introduced into the condenser 37 through a second inlet 78 and, after releasing heat to the process liquid 13 flowing in counterflow, leaves the condenser 37 through a second outlet 77. The heated process liquid 13 leaves the condenser 37 through the first outlet 66 and is returned through the first bypass, so that the process liquid 13 heated in the condenser 37 can still be passed through the first HE 31 and further heated there.

A second bypass to the evaporator 39 is provided in the cooling line system 96, the second bypass being provided downstream of the first pump 71 and upstream of the first inlet 69 of the second HE 30. The process liquid 13 is directed via a second metering device 41_2 to a first inlet 73 of the evaporator 39, cooled therein, exits the evaporator 39 via a first outlet 74, and is then returned via the bypass so that the process liquid 13 cooled in the evaporator 39 can still be directed through the second HE 30 and further cooled there. Cooling of the process liquid 13 in the evaporator 39 is accomplished by the transfer liquid flowing around in the heat pump 35 and being introduced into the evaporator 39 via a second inlet 75, flowing there in counterflow to the process liquid 13 and leaving the evaporator 39 again via a second outlet 76 after having absorbed heat from the process liquid 13.

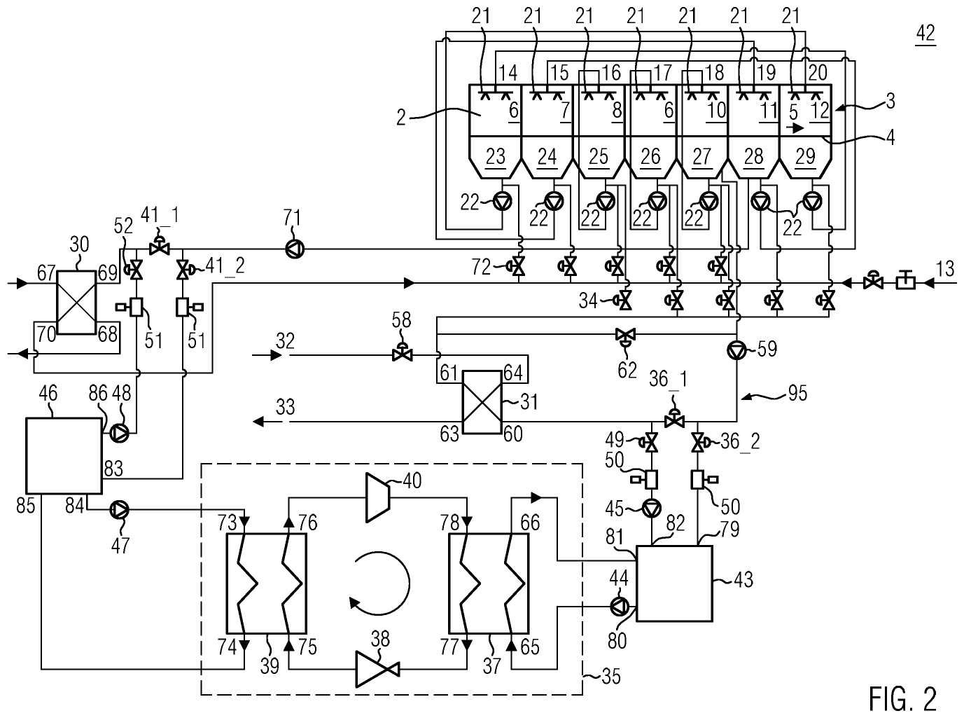

FIG. 2 shows a schematic representation of a second embodiment of a plant 42 for pasteurizing foodstuffs or beverages filled in closed containers 2. The elements already described with respect to FIG. 1 are not explained again here.

A heat tank 43 is provided in the first bypass upstream of the condenser 37. Via the first metering device 36_2, process liquid 13 can be introduced into a first inlet 79 of the heat tank 43. From the heat tank 43, process liquid 13 can be fed from a first outlet 80 via a third pump 44 through the condenser 37 and heated there, as already described with respect to FIG. 1. This heated process liquid 13 is returned to the heat tank 43 through a second inlet 81. Via a fourth pump 45, the process liquid 13 can be pumped back out of the heat tank 43 through a second outlet 82 to the heating line system 95 and thus to the first HE 31; a third metering device 49 is provided downstream of the fourth pump 45 in the first bypass. Hot water can also be used in the first HE 31 instead of steam 32.

Optionally, upstream of the first inlet 79 of the heat tank 43 and downstream of the fourth pump 45 in the first bypass, corresponding first and second spring valves 50 may be provided which may be closed to allow the heat pump 35 to be disconnected.

A cooling tank 46 is provided in the second bypass upstream of the evaporator 39. Via the second metering device 41_2, process liquid 13 can be introduced into a first inlet 83 of the cooling tank 46. From the cooling tank 46, process liquid 13 can be fed from a first outlet 84 via a fifth pump 47 through the evaporator 39 and cooled there, as already described with respect to FIG. 1. This cooled process liquid 13 is returned to the cooling tank 46 through a second inlet 85. Via a sixth pump 48, the process liquid 13 can be pumped back from the cooling tank 46 through a second outlet 86 into the cooling line system 96 upstream of the second HE 30; a fourth metering device 52 is provided downstream of the sixth pump 48 in the second bypass.

Optionally, upstream of the first inlet 83 of the cooling tank 46 and downstream of the sixth pump 48 in the second bypass, third and fourth spring valves 51 may be provided, correspondingly, which may be closed to allow the heat pump 35 to be excluded.

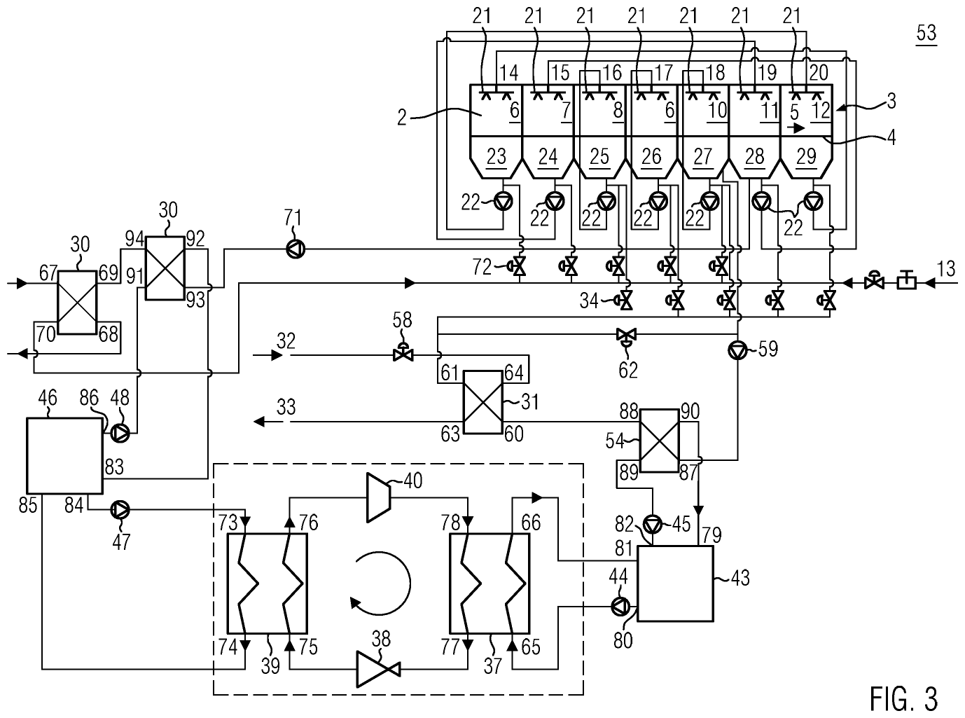

FIG. 3 schematically illustrates a third embodiment of a plant 53 for pasteurizing foodstuffs or beverages filled in closed containers 2. The elements already described with respect to FIGS. 1 and 2 are not explained again here.

In the third embodiment, a third HE 54 is provided in the heating line system 95 upstream of the first HE 31 so that the process liquid 13 circulates through the third HE 54 and the first HE 31. In counterflow to the process liquid 13, liquid from the heat tank 43 circulates in the third HE 54, which is pumped from the second outlet 82 of the heat tank 43 via the fourth pump 45 and, after passing through the third HE 54—i.e., the liquid is introduced into the third HE 54 via a first inlet 89 and discharged via a first outlet 90—is returned to the heat tank 43 via the first inlet 79. The process liquid 13 is introduced into the third HE 54 via a second inlet 87 and discharged via a second outlet 88, and then passes to the second inlet 60 of the first HE 31.

Thus, there are separate circuits: one for the process liquid 13 flowing through the first HE 31 and the third HE 54, and one for the liquid flowing through the heat tank 43, the third HE 54 and the condenser 37. The liquid from the heat tank 43 is pumped through the condenser 37 of the heat pump 35 by the third pump 44, as previously in the second embodiment, and returns to the heat tank 43.

A fourth HE 55 is provided in the cooling line system 96 upstream of the second HE 30, so that the process liquid 13 circulates through the fourth HE 55 and the first HE 30. In counterflow to the process liquid 13, liquid from the cooling tank 46 circulates in the fourth HE 55, is pumped from the second outlet 86 of the cooling tank 46 via the sixth pump 48, and is returned to the cooling tank 46 via the first inlet 83 after passing through the fourth HE 55—i.e., the liquid is introduced into the fourth HE 55 via a first inlet 91 and discharged via a first outlet 92. The process liquid 13 is introduced into the fourth HE 55 via a second inlet 93 and discharged via a second outlet 94, and then passes to the second inlet 69 of the second HE 30 where it can be further cooled.

Thus, there are separate circuits: one for the process liquid 13 flowing through the second HE 30 and the fourth HE 55, and one for the liquid flowing through the cooling tank 46, the evaporator 39 and the fourth HE 55. The liquid from the cooling tank 46 is pumped through the evaporator 39 of the heat pump 35 by the fifth pump 47, as previously in the second embodiment, and then returns to the cooling tank 46.

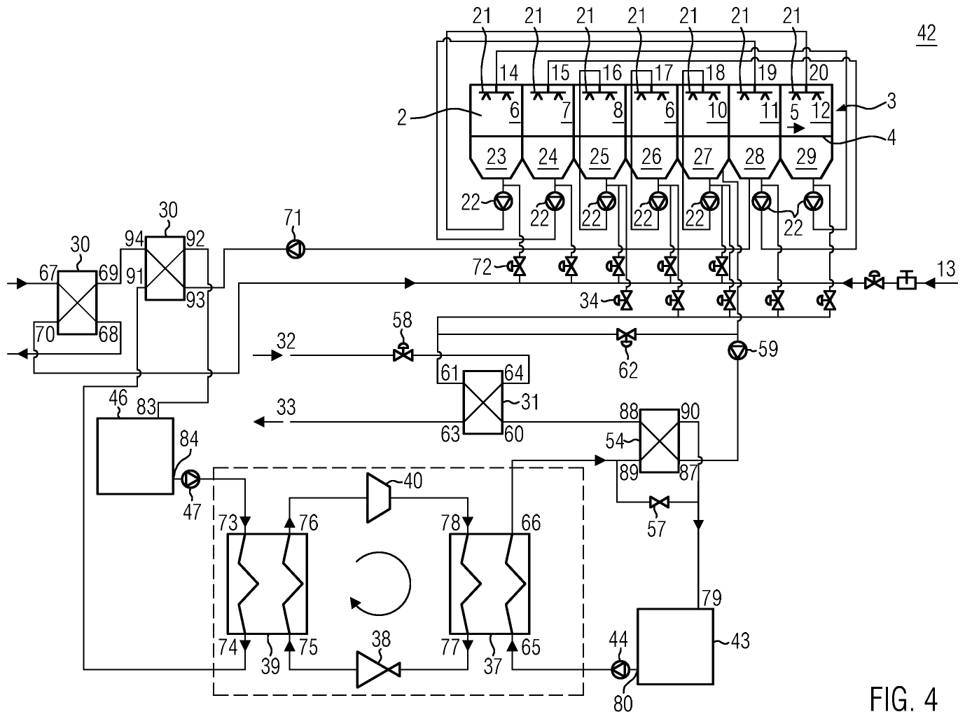

FIG. 4 shows a fourth embodiment of a plant 56 for pasteurizing foodstuffs or beverages filled in closed containers 2. The elements already described with respect to FIGS. 1, 2 and 3 are not explained again here.

Compared to the third embodiment, in the fourth embodiment the first outlet 66 of the condenser 37 leads to the first inlet 89 of the third HE 54 and not—as in the third embodiment—to the second inlet 81 of the heat tank 43; therefore, the fourth pump 45 can be saved between the second outlet 82 of the heat tank 43 and the first inlet 89 of the third HE 54. Between the supply line to the first inlet 89 of the third HE 54 and the supply line to the first inlet 79 of the heat tank 43, a further bypass controllable via a valve 57 is provided.

Moreover, the first outlet 74 of the evaporator 39 leads to the first inlet 91 of the fourth HE 55 and not—as in the third embodiment—to the second inlet 85 of the cooling tank 46; therefore, the sixth pump 48 can be saved between the second outlet 86 of the cooling tank 46 and the first inlet 91 of the fourth HE.

It is to be understood that the above description is intended to be illustrative, and not restrictive. Other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A plant for pasteurizing foodstuffs or beverages filled into closed containers by way of a process liquid, wherein the plant comprises:
at least one heating zone;
at least one pasteurizing zone; and
at least one cooling zone, wherein the at least one heating zone, the at least one pasteurizing zone and the at least one cooling zone are arranged successively in a conveying direction of the closed containers, each of the at least one heating zone, the at least one pasteurizing zone and the at least one cooling zone being assigned:
a sprinkling device for discharging the process liquid; and
a collecting region for receiving the discharged process liquid;
a conveyor for conveying the closed containers in the conveying direction through the at least one heating zone, the at least one pasteurizing zone and the at least one cooling zone;
a first heat exchanger configured to provide heat from a heat source to the process liquid from the collecting region of the at least one pasteurizing zone, wherein the first heat exchanger includes a first line connection to the collecting region of the at least one pasteurizing zone and a second line connection to one or more feeds to the sprinkling device of the at least one heating zone via a pressure-closed heating line system;
a second heat exchanger coupled to a cooling plant for cooling the process liquid from the collecting region of the at least one cooling zone, wherein the second heat exchanger includes a third line connection to the collecting region of the at least one cooling zone and a fourth line connection to one or more feeds to the sprinkling device of the at least one cooling zone via a pressure-closed cooling line system; and
a heat pump comprising a condenser and an evaporator (39), wherein the heat pump is configured to supply additional heat to the process liquid in the pressure-closed heating line system via the condenser, and wherein the heat pump is additionally configured to cool the process liquid in the pressure-closed cooling line system via the evaporator.

2. The plant according to claim 1, wherein:
the first heat exchanger is further connected by a first pipeline to the one or more feeds to the sprinkling device of the at least one pasteurizing zone via the pressure-closed heating line system; and
the second heat exchanger is further connected by a second pipeline to the one or more feeds to the sprinkling device of the at least one cooling zone via the pressure-closed cooling line system.

3. The plant according to claim 1, wherein the plant is configured to provide an overpressure in a range of 0.5·10⁵ Pa to 2.5·10⁵ Pa in the pressure-closed heating line system relative to an ambient pressure.

4. The plant according to claim 1, wherein the plant is configured to supply the process liquid from the collecting region of the at least on cooling zone via a first pump via the pressure-closed cooling line system to a first inlet of the second heat exchanger.

5. The plant according to claim 1, wherein an amount of supplied heat of the heat source is controllable via a metering device.

6. The plant according to claim 1, wherein the plant is configured to supply the process liquid from the collecting region of the at least one pasteurizing zone to a second inlet of the first heat exchanger via a second pump via the pressure-closed heating line system.

7. The plant according to claim 1, further comprising:
a first bypass to the condenser in the pressure-closed heating line system; and
a second bypass to the evaporator in the pressure-closed cooling line system.

8. The plant according to claim 7, wherein the first bypass leads from the pressure-closed heating line system through a first metering device to a first inlet of the condenser, through the condenser and from a first outlet of the condenser to the pressure-closed heating line system, and wherein the second bypass leads from the pressure-closed cooling line system through a second metering device to a first inlet of the evaporator, through the evaporator and from a first outlet of the evaporator to the pressure-closed cooling line system.

9. The plant according to claim 7, wherein a heat tank is provided in the first bypass and a cooling tank is further in the second bypass.

10. The plant according to claim 9, further comprising:
a first inlet to the heat tank downstream of a first metering device and a first outlet of the heat tank leads to the first inlet of the condenser through a third pump, wherein the first outlet of the condenser leads to a second inlet of the heat tank and a second outlet of the heat tank leads through a fourth pump and a third metering device back to the pressure-closed heating line system; and
a first inlet to the cooling tank downstream of a second metering device, wherein a first outlet of the cooling tank leads through a pump to the first inlet of the evaporator, wherein the first outlet of the evaporator leads to a second inlet of the cooling tank and a second outlet of the cooling tank leads through a sixth pump and a fourth metering device back to the pressure-closed cooling line system.

11. The plant according to claim 10, further comprising:
a first spring valve between the first metering device and the first inlet of the heat tank; and
a second spring valve between the fourth pump and the third metering device.

12. The plant according to claim 10, further comprising:
a third spring valve between the second metering device and the first inlet of the cooling tank; and
a fourth spring valve between the sixth pump and the fourth metering device.

13. The plant according to claim 1, further comprising:
a third heat exchanger through which the pressure-closed heating line system at least partially passes, wherein the third heat exchanger is configured to supply heat to the process liquid in the pressure-closed heating line system from a heat tank of the plant, and wherein the third heat exchanger is connected by a pipeline to the heat tank and the condenser; and
a fourth heat exchanger through which the pressure-closed cooling line system at least partially passes, wherein the fourth heat exchanger is connected by a pipeline to a cooling tank of the plant and to the evaporator, and wherein the fourth heat exchanger is configured to cool the process liquid in the pressure-closed cooling line system.

14. The plant according to claim 13, wherein the third heat exchanger is disposed upstream of the first heat exchanger and the fourth heat exchanger is disposed upstream of the second heat exchanger.

15. The plant according to claim 13, wherein;
a first pipe leads from a first outlet of the third heat exchanger to a first inlet of the heat tank, from a first outlet of the heat tank through a third pump to a first inlet of the condenser, from a first outlet of the condenser to a second inlet of the heat tank, and from a second outlet of the heat tank through a fourth pump to a first inlet of the third heat exchanger; and
a second pipe leads downstream of a first outlet of the fourth heat exchanger to a first inlet of the cooling tank, from a first outlet of the cooling tank through a fifth pump to a first inlet of the evaporator, from a first outlet of the evaporator to a second inlet of the cooling tank, and from a second outlet of the cooling tank through a sixth pump to a first inlet of the fourth heat exchanger.

16. The plant according to claim 13, wherein;
a first pipe leads from a first outlet of the third heat exchanger to a first inlet of the heat tank, from a first outlet of the heat tank through a third pump to a first inlet of the condenser, and from a first outlet of the condenser to a first inlet of the third heat exchanger, wherein in addition a bypass is provided around the third heat exchanger, which leads from upstream of the first inlet of the third heat exchanger downstream of the first outlet of the third heat exchanger; and
a second pipe leads from a first outlet of the fourth heat exchanger to a first inlet of the cooling tank, from a first outlet of the cooling tank through a fifth pump to a first inlet of the evaporator, and from a first outlet of the evaporator to a first inlet of the fourth heat exchanger.

17. The plant according to claim 1, wherein the first heat exchanger is further connected by a pipeline to the one or more feeds to the sprinkling device of the at least one heating zone via the pressure-closed heating line system.

18. The plant according to claim 1, wherein the second heat exchanger is further connected by a pipeline to the one or more feeds to the sprinkling device of the at least one pasteurizing zone via the pressure-closed cooling line system.

19. The plant according to claim 1, wherein the plant is configured to provide an overpressure in a range of 0.5·10⁵ Pa to 2.5·10⁵ Pa in the pressure-closed cooling line system relative to an ambient pressure.

20. The plant according to claim 7, wherein the first bypass is disposed upstream of the first heat exchanger, and wherein the second bypass is disposed upstream of the second heat exchanger.
